(19) United States
(12) Patent Application Publication
(10) Pub. No.: US 2007/0199429 A1
(43) Pub. Date: Aug. 30, 2007

(54) DRUM STAND WITH A VIBRATION-REDUCING DEVICE

(76) Inventor: Wu-Hong Hsieh, Lu Chou City (TW)

Correspondence Address: Rabin & Berdo, P.C., Suite 500, 1101 14th Street, Washington, DC, 20005, US

(21) Appl. No.: 11/362,901

(22) Filed: Feb. 28, 2006

(51) Int. Cl. G10D 13/02

(52) U.S. Cl. 84/422.1

(57) ABSTRACT

A drum stand has a base, a seat, a pivotal member, a supporting device and a vibration-reducing member. The seat is mounted on a top end of the base and can be rotated relative to the base. The pivotal member is pivotally connected to the seat and the supporting device is mounted on the pivotal member to hold a side drum. The vibration-reducing member, which is mounted between the pivotal member and the supporting device, has a cylinder and an inner bar movable relative to the cylinder. A spring is mounted around the cylinder so that the spring can substantially resumes to its original status to reduce the vibration of the side drum when the side drum is beaten.

### BACKGROUND OF THE INVENTION

1. Field of the Invention

The present invention relates to a drum stand, and more particularly to a drum stand which has a vibration-reducing device to enable the drum to exhibit desired sound.

2. Description of the Related Art

A suite of drums comprises bass drums, tenor drums, side drums, and cymbals, etc. When the side drums are beaten, the beating power can be violent or weak to meet the performance's demand. Hence, the side drum is supported by a conventional stand and prevents from falling onto the ground. However, because the side drum vocalizes due to the vibration of a batter head thereof, the side drum doesn't present desired sound when it is fastened heavily by the conventional stand.

Therefore, the invention provides a drum stand to mitigate or obviate the aforementioned problems.

### SUMMARY OF THE INVENTION

The main objective of the present invention is to provide a drum stand which can lessen the beating power applied onto a side drum to exhibit desired sound.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a drum stand in accordance with the present invention;

FIG. 2 is another perspective view of the drum stand in FIG. 1;

FIG. 3 is a perspective view of the drum stand in FIG. 1;

FIG. 4 is a side view of a side drum attached to the drum stand in FIG. 1; and

FIG. 5 is an operational side view of the side drum with the drum stand in FIG. 4.

### DETAILED DESCRIPTION OF THE PREFERRED EMBODIMENT

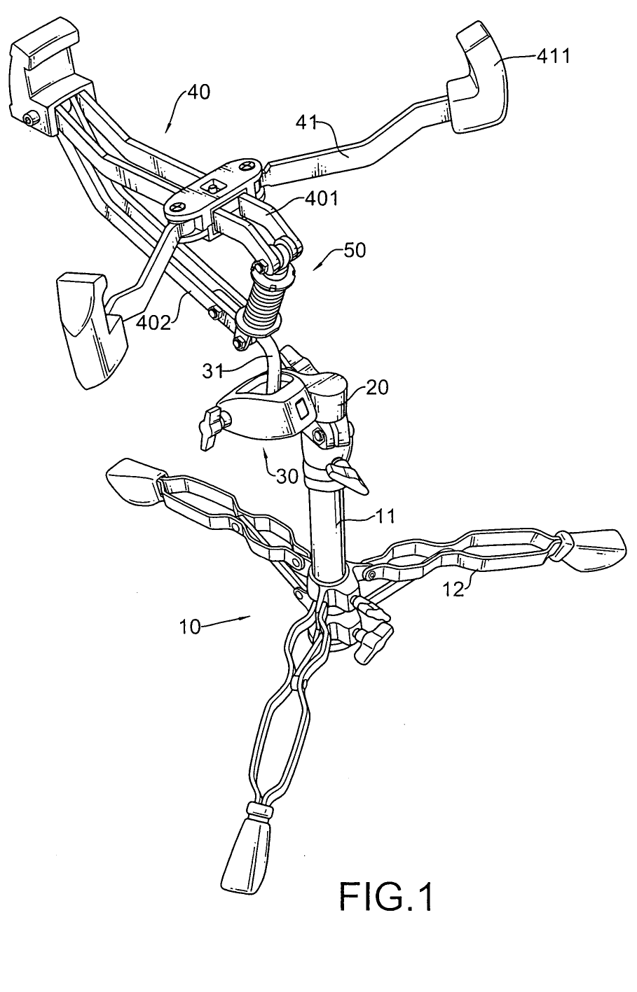

With reference to FIG. 1, a drum stand has a base (10), a seat (20), a pivotal member (30), a supporting device (40), and a vibration-reducing device (50).

The base (10) has a post (11) which has a desired height to meet the performer's requirement. Multiple feet (12) are respectively mounted at a lower end of the post (11) and can be pivotally rotated relative to the post (11). The seat (20) is rotatably attached to a top end of the post (11). The pivotal member (30) is pivotally attached one side of the seat (20). The pivotal member (30) has a rod (31) inclinedly extending from the pivotal member so that an angle between the pivotal member (30) and the seat (20) can be changed. The supporting device (40) is connected to the rod (31) on the pivotal member (30). The supporting device (40) has a first bracket (401) and a second bracket (402) corresponding to the first bracket (401). One end of the second bracket (402) is securely attached to the rod (31) on the pivotal member (30). The supporting device (40) has multiple arms (41) pivotally connected to and transversely extending out from the first bracket (401), and multiple fingers (411) are respectively mounted at free ends of the arms (41). An end of the second bracket (402) is pivotally connected to the free end of one of the arms (41) adjacent to the finger (411). The distance between the arms (41) can be changed by pivotally rotating the arms (41) relative to the first bracket (401).

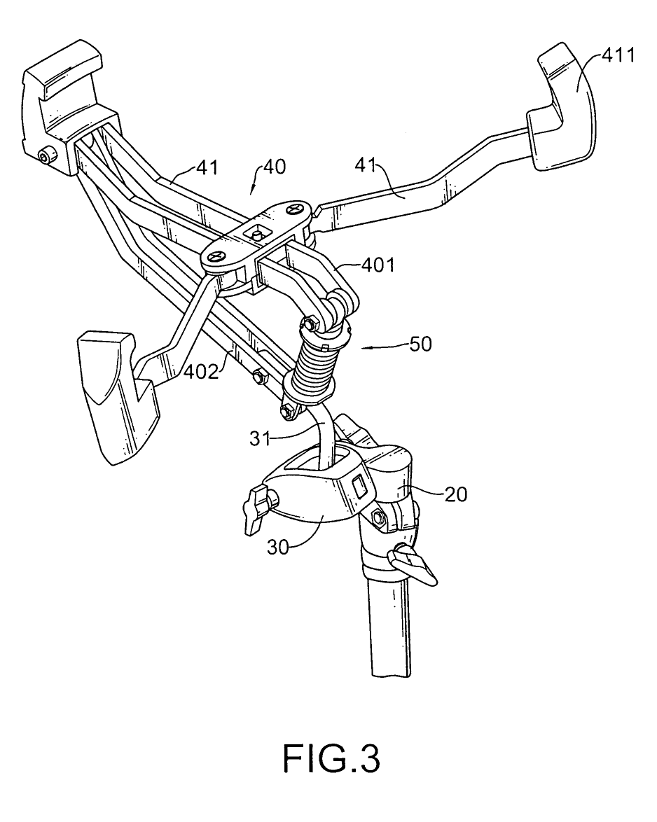

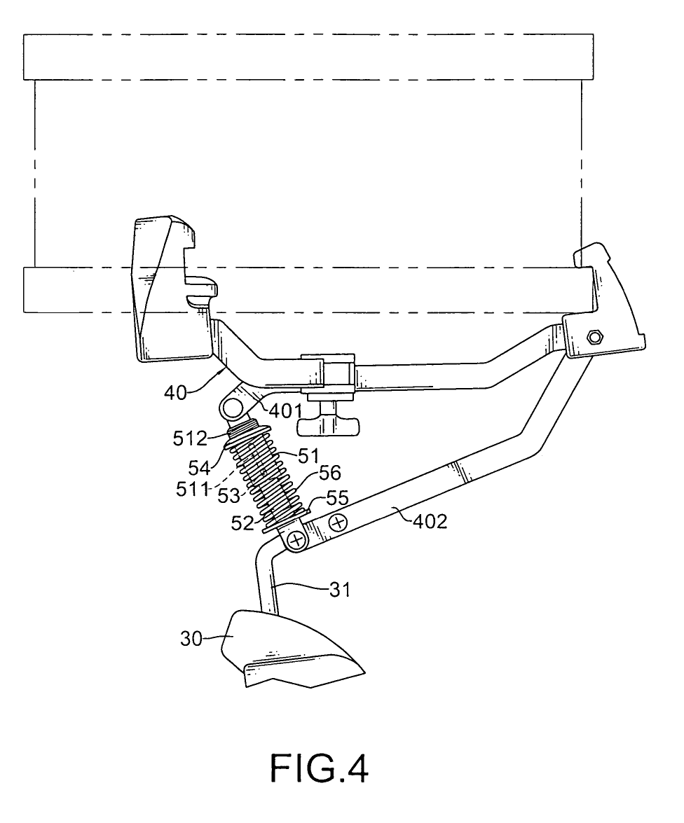

With reference to FIGS. 3 and 4, the vibration-reducing device (50) is mounted between the first bracket (401) and the second bracket (402) and has a cylinder (51), an inner bar (52), a pin (53), an upper plane (54), a lower plane (55) and a spring (56). The cylinder (51) has an open end defined in a lower end thereof and a slot (51) defined longitudinally in the periphery of the cylinder (51). A thread (512) is defined in the peripheral at an upper end of the cylinder (51), and the upper plane (54) has a threaded hole defined therein to screw with the thread (512) on the cylinder (51). A lower end of the inner bar (52) is securely mounted at a first side of the lower plane (55) and an upper end of the inner bar (52) is slidably inserted into the open end of the cylinder (51). The pin (53) is inserted into the slot (511) and the inner bar (52) in turn, and the spring (56) is mounted around the inner bar (52) and cylinder (51). An upper end of the spring (56) abuts against the upper plane (54) and a lower end of the spring (56) abuts against the lower plane (55).

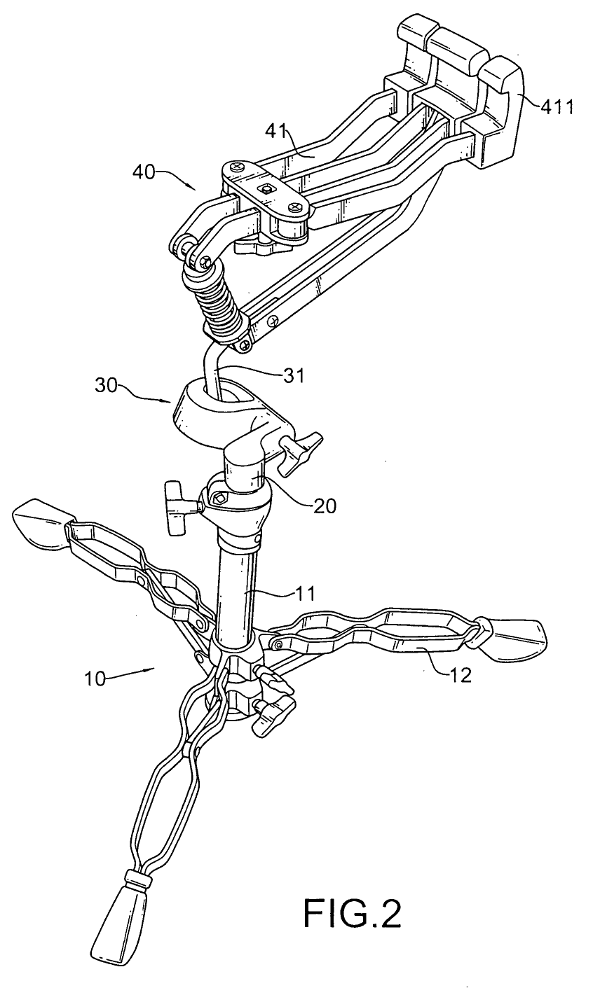

With reference to the FIGS. 2-4, the seat (20) is mounted at an upper end of the post (11) and can be rotated relative to the post (11). The pivotal member (30) is pivotally mounted at a side of the seat (20), and the supporting device (40) is securely connected to a free end of the rod (31). The upper end of the cylinder (51) is pivotally connected to the first bracket (401), and a second side of the lower plane (55) is pivotally connected to the rod (31) and the second bracket (402).

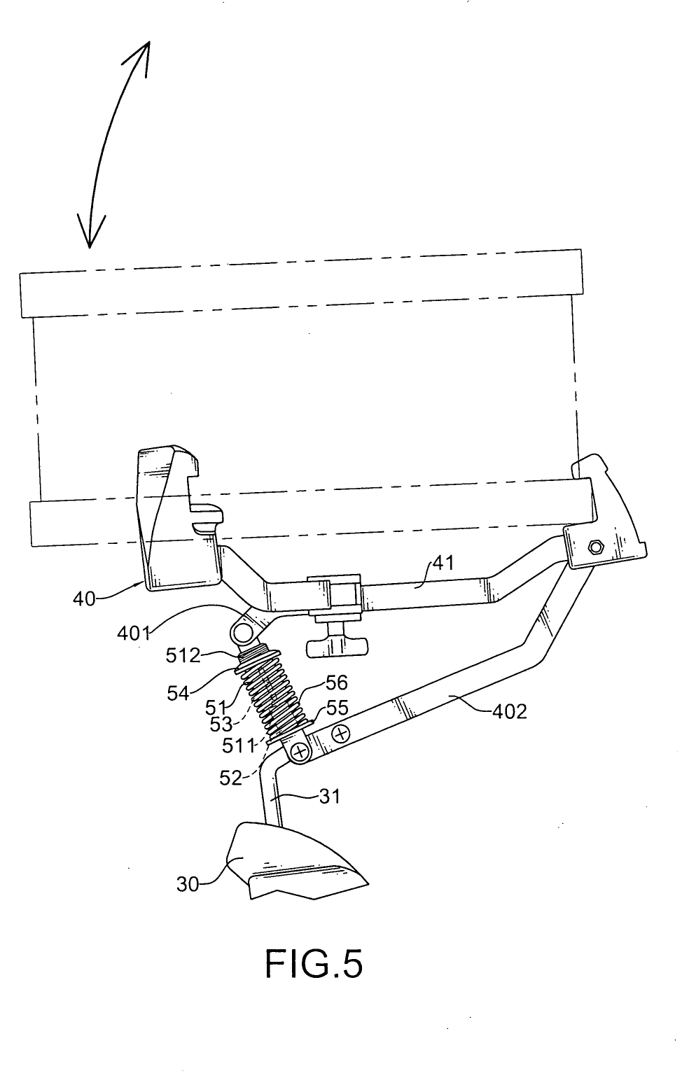

With reference to FIG. 5, a side drum is securely held between the fingers (411) on the arms (40) of the supporting device (40). When the side drum is beaten for performance, the cylinder (51) will be pressed by the first bracket (401). Consequently, the first bracket (401) is moved toward the second bracket (402), and the cylinder (51) is moved relative to the inner bar (52). The pin (53) slides along the slot (511), and the distance between the upper plane (54) and the lower plane (55) is shortened to compress the spring (56). Hence, the supporting device (40) is substantially resumed to its original status by the resilient force of the spring (56) and the vibration applied onto the supporting device (40) is reduced. The distance between the upper plane (54) and the lower plane (55) can be changed by rotating the thread (512) of the upper plane (54) relative to the threaded hole of the cylinder (51). Accordingly, the resilient effect provided by the spring (56) is adjustable based on needs of users.

It is to be understood, however, that even though numerous characteristics and advantages of the present invention have been set forth in the foregoing description, together with details of the structure and function of the invention, the disclosure is illustrative only. Changes may be made in details, especially in matters of shape, size, and arrangement of parts within the principles of the invention to the full extent indicated by the broad general meaning of the terms in which the appended claims are expressed.

What is claimed is:

1. A drum stand comprising:
a base;
a seat rotatably mounted on an upper end of the base;
a pivotal member pivotally mounted on the seat;
a supporting device securely connected to the pivotal member; and
a vibration-reducing member mounted between the pivotal member and the supporting device and having
a cylinder pivotally mounted with the supporting device and having
an upper end,
a lower end,
a slot defined longitudinally defined in a periphery of the cylinder,
an upper plane mounted on the upper end of the cylinder adjacent to the supporting device,
an inner bar slidably inserted into the lower end of the cylinder and having a lower end,
a lower plane securely attached to the lower end of the inner bar and having a first side securely attached to the lower end of the inner bar and a second side pivotally connected to the pivotal member,
a pin slidably inserted into the slot and fastened to the inner bar,
a spring mounted around the cylinder and the inner bar wherein an upper end of the spring abuts against the upper plane and a lower end of the spring abuts against the lower plane.

2. The drum stand as claimed in claim 1, wherein a thread is defined in the peripheral at the upper end of the cylinder and the upper plane is screwed onto the thread on the cylinder.

3. The drum stand as claimed in claim 1, wherein the supporting device has
a first bracket,
a second bracket securely connected to the pivotal member,
multiple arms pivotally connected to and transversely extending from the first bracket, wherein the second bracket is pivotally connected to one of the arms, and
multiple fingers securely attached to the arms, respectively,
an upper end of the vibration-reducing member is pivotally connected to the first bracket,
the pivotal member has a rod inclinedly extending from the pivotal member and securely connected to the second bracket, and
the second side of the lower plane is pivotally connected to the rod and the second bracket.
